(19) United States
(12) Patent Application Publication
(10) Pub. No.: US 2006/0208525 A1
(43) Pub. Date: Sep. 21, 2006

(54) Tonneau truck cover opening system

(76) Inventor: Stanley C. Jonsson, San Mateo, CA (US)

Correspondence Address: GORDON & REES LLP, 101 WEST BROADWAY, SUITE 1600, SAN DIEGO, CA, 92101, US

(21) Appl. No.: 11/080,480

(22) Filed: Mar. 16, 2005

(51) Int. Cl. B60P 7/04

(52) U.S. Cl. 296/100.02

(57) ABSTRACT

A system to assist in opening a Tonneau truck cover, having: a housing configured to be mounted to an interior side wall of a pickup truck underneath of a Tonneau truck cover; a biasing mechanism in the housing; and a support in contact with the biasing mechanism, wherein the biasing mechanism is configured to urge the support upwardly so as to lift the Tonneau truck cover a distance sufficient for an operator to insert a portion of their hand underneath the Tonneau truck cover when the Tonneau truck cover is unlatched.

### TECHNICAL FIELD

The present invention provides a mechanism to assist in holding open a standard Tonneau pickup truck cover such that an operator can open the Tonneau pickup truck cover with only one hand.

### BACKGROUND OF THE INVENTION

It is very difficult to both unlatch and lift open a standard Tonneau truck cover with one hand. This is because an operator must typically first unlatch the Tonneau truck cover and then lift open the Tonneau truck cover. An operator typically requires one hand to unlatch the Tonneau truck cover, and the other hand to lift open the Tonneau truck cover.

Therefore, if an operator is carrying an object to be placed in the back of the truck, (s)he is typically forced to place the object on the ground near the back of the truck, and then use both hands to open the Tonneau truck cover. Next, the operator must lift the object off of the ground and place it in the back of the truck.

A variety of systems have been developed td open, or to hold open, a standard Tonneau pickup truck cover. Examples of systems that open Tonneau truck covers are found in U.S. Pat. Nos. 5,503,450; 6,042,173; 6,076,881; 6,623,062; and 6,830,281. Although these systems do assist in opening a Tonneau truck cover, they are quite complex and expensive.

An example of a truck bed cover lock is found in U.S. Pat. No. 6,702,358; and an example of a latching assembly for a truck bed cover is found in U.S. Pat. No. 6,676,174. Unfortunately, these systems only lock/unlatch the Tonneau truck cover, they do not assist in actually opening the truck cover.

What is instead desired is a system in which an operator can open a Tonneau truck cover with one hand, regardless of whether that one hand is also used to unlatch the Tonneau truck cover. With such a system, the operator would not be forced to place objects on the ground when unlatching and opening the Tonneau truck cover.

### SUMMARY OF THE INVENTION

The present invention provides a system to assist in opening a Tonneau truck cover, including: a housing configured to be mounted to an interior side wall of a pickup truck underneath of a Tonneau truck cover; a biasing mechanism in the housing; and a support in contact with the biasing mechanism, wherein the biasing mechanism is configured to urge the support upwardly so as to lift the Tonneau truck cover a distance sufficient for an operator to insert a portion of their hand underneath the Tonneau truck cover when the Tonneau truck cover is unlatched.

In preferred embodiments, the distance sufficient for an operator to insert a portion of their hand under the Tonneau truck cover is less than 3 inches.

In preferred embodiments, the biasing mechanism is a spring that is compressed when the Tonneau truck cover is closed, and extended when the Tonneau truck cover is opened. The top surface of the support may optionally be covered with plastic or with fabric.

### BRIEF DESCRIPTION OF THE DRAWINGS

FIG. 1 is a perspective view of the present invention in operation.

FIG. 2 is a schematic side elevation view of the present invention with the Tonneau truck cover in a closed (i.e.: latched shut) position.

FIG. 3 is a schematic side elevation view of the present invention with the Tonneau truck cover in a “popped open” (unlatched) position.

FIG. 4 is a schematic side elevation view of the present invention with the Tonneau truck cover in a fully opened position.

### DETAILED DESCRIPTION OF THE DRAWINGS

The present invention provides a system to assist in opening a standard Tonneau truck cover with one-handed operation.

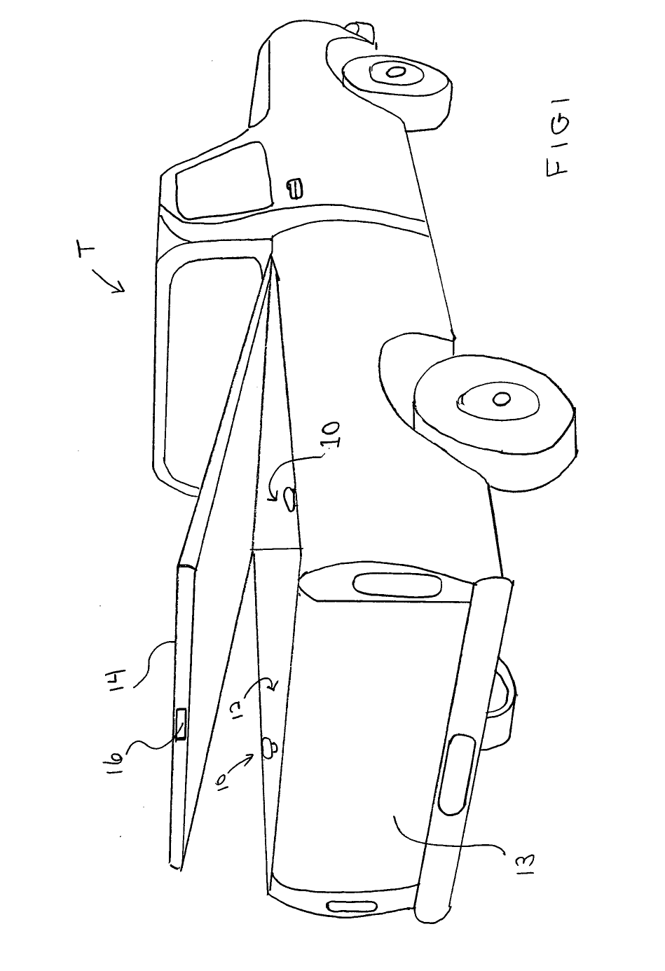

Referring first to FIG. 1, a pair of Tonneau truck cover pop-up mechanisms 10 are mounted on the inside walls 12 of the back of a pickup truck T, directly underneath Tonneau truck cover 14.

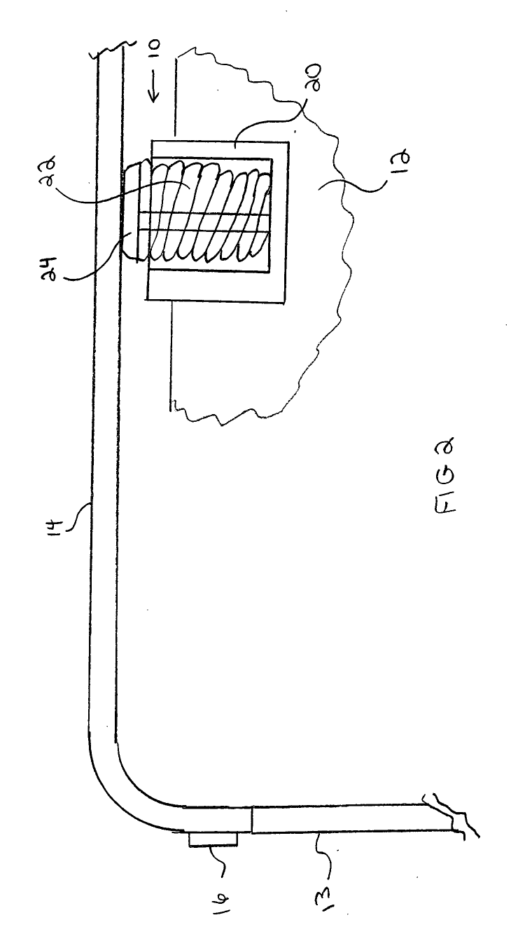

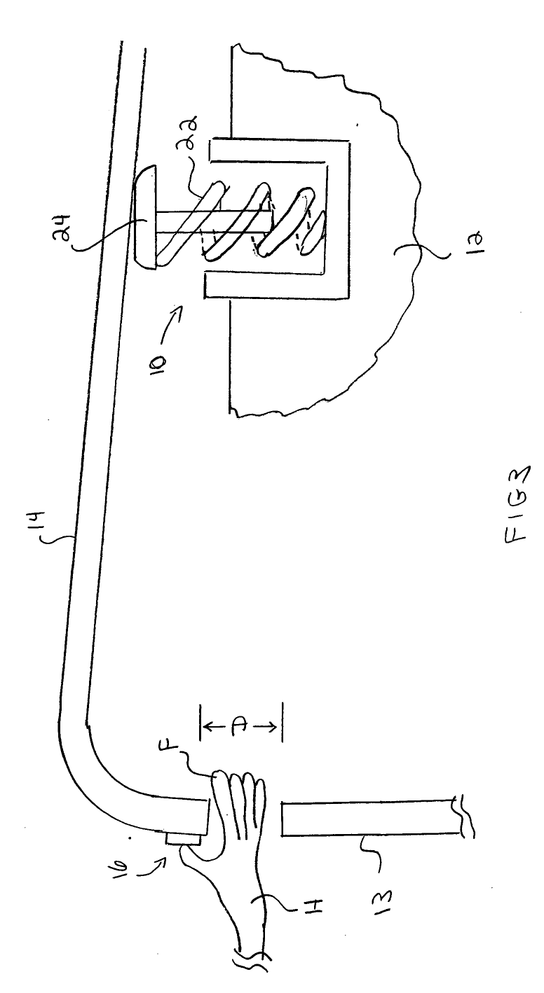

As shown in FIGS. 2 and 3, pop-up mechanisms 10 operate to slightly lift Tonneau truck cover 14 after latch 16 has been released, as follows.

Pop-up mechanism 10 includes a housing 20 configured to be mounted to the interior of side wall 12 of a pickup truck underneath Tonneau truck cover 14. Housing 20 includes a biasing mechanism 22, which may be a simple spring as illustrated. The present invention is not so limited, however, since biasing mechanism 22 may also include a hydraulic system, or any other system suitable for lifting Tonneau truck cover 14, as will be explained. Biasing mechanism 22 is configured to push support 24 upwardly, as follows.

As seen in FIG. 3, the operator uses their hand H to unlatch latch 16. As this time, biasing mechanism 22 will push support 24 upwardly, thereby raising Tonneau truck cover 14 by a distance D at its back end (i.e.: away from the top of rear wall 13 of the pickup tuck). Distance D is a distance sufficient for an operator to insert one or more fingers F underneath the back end of Tonneau truck cover 14, placing the palm of their hand under the truck cover, as shown. Distance D need not be a large distance. In one exemplary embodiment, distance D is less than 3 inches.

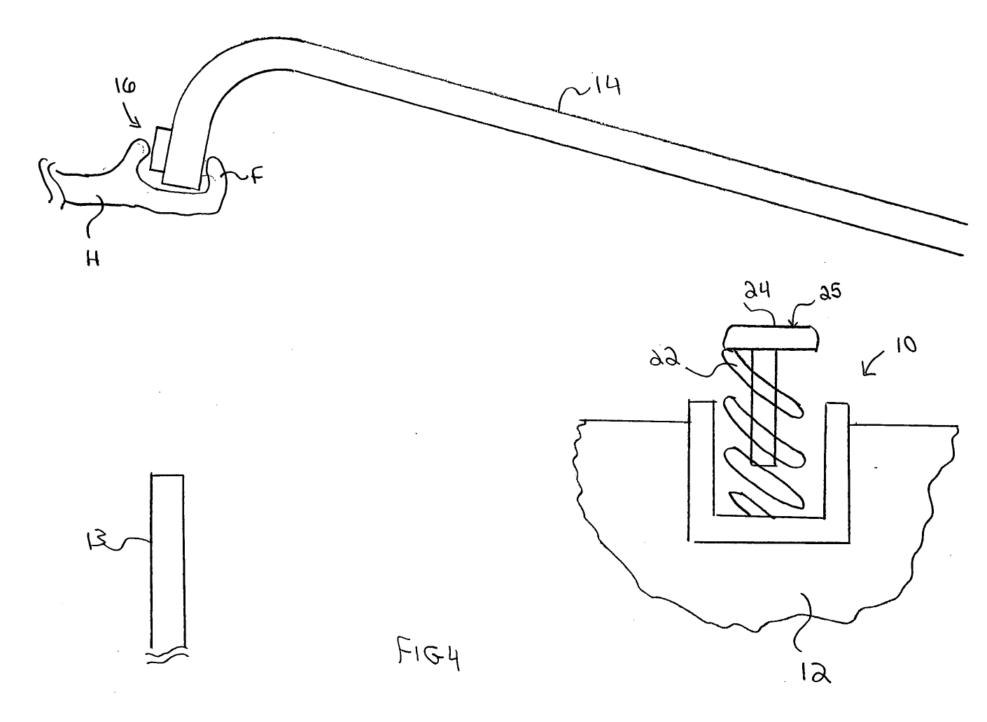

Next, as seen in FIG. 4. the operator's hand H and finger(s) F is then used to fully lift open Tonneau truck cover 14. As can be seen, Tonneau truck cover 14 does not touch support 24 when the Tonneau truck cover 14 is in its fully open position.

The primary advantage of the present invention is that it “pops open” the Tonneau truck cover 14 when the operator unlatches latch 16 such that a small space gap D is provided for the operator to insert one or more of their finger(s) F under the back end of the Tonneau truck cover 14 so that it can be easily lifted open.

As can be seen in FIG. 2, biasing mechanism 22 is compressed when Tonneau truck cover 14 is closed. As can be seen in FIGS. 3 and 4, biasing mechanism 22 is extended when Tonneau truck cover 14 initially pops open (FIG. 3) or is fully opened (FIG. 4).

In various optional embodiments, a top surface 25 of support 24 is covered with plastic, or with fabric. However, any suitable material may be used to cover top surface 25 of support 24, or no covering at all.

What is claimed is:

1. A system to assist in opening a Tonneau truck cover, comprising:
a housing configured to be mounted to an interior side wall of a pickup truck underneath of a Tonneau truck cover;
a biasing mechanism in the housing; and
a support in contact with the biasing mechanism, wherein the biasing mechanism is configured to urge the support upwardly so as to lift the Tonneau truck cover a distance sufficient for an operator to insert a portion of their hand underneath the Tonneau truck cover when the Tonneau truck cover is unlatched.

2. The system of claim 1, wherein the distance sufficient for an operator to insert the portion of their hand under the Tonneau truck cover is less than 3 inches.

3. The system of claim 1, wherein the biasing mechanism is compressed when the Tonneau truck cover is closed, and wherein the biasing mechanism is extended when the Tonneau truck cover is opened.

4. The system of claim 1, wherein a top surface of the support is covered with plastic.

5. The system of claim 1, wherein a top surface of the support is covered with fabric.
